(19) United States
(12) Patent Application Publication
(10) Pub. No.: US 2009/0276647 A1
(43) Pub. Date: Nov. 5, 2009

(54) STORAGE DEVICE POWER CONSUMPTION STATE

(75) Inventor: James Boyd, Hillsboro, OR (US)

Correspondence Address: The Law Offices of Christopher K. Gagne;c/o CPA Global, B.O. Box 52050, Minneapolis, MN, 55402, US

(73) Assignee: Intel Corporation

(21) Appl. No.: 12/112,180

(22) Filed: Apr. 30, 2008

(51) Int. Cl. G06F 1/32

(52) U.S. Cl. 713/320

(57) ABSTRACT

In an embodiment, an apparatus is provided that includes circuitry to determine, at least in part, whether respective idle conditions have been satisfied for respective storage devices. If the circuitry determines, at least in part, that at least one respective storage device comprised in the respective storage devices satisfies at least one respective idle condition, the circuitry is also to issue at least one request that the at least one respective storage device enter, independently from at least one other respective storage device comprised in the respective storage devices, a respective relatively lower power consumption state compared to a respective relatively higher power consumption state. Of course, many alternatives, modifications, and variations are possible without departing from this embodiment.

### FIELD

This disclosure relates to storage device power consumption state.

### BACKGROUND

In one conventional redundant array of independent disks (RAID) power management scheme, a host system is coupled to the RAID. An operating system executing in the host system determines if none of the disks in the RAID have been accessed within the predetermined time period, and if such is the case, the operating system issues a request that the RAID disks power down.

In this conventional power management scheme, all of the disks in the RAID are viewed by the operating system as constituting a single unit for purposes of RAID power management. That is, power management decisions are not made for each disk independently of any other disk in the RAID. Instead, either all of the disks in the RAID are powered down, or none of the disks in the RAID are powered down. This is unfortunate, since depending upon the particular RAID level implemented, the nature of the disks in the RAID (e.g., whether one or more of the RAID disks is a solid state disk instead of a hard disk), and the nature of the disk access that may be requested, it may be possible to satisfy the disk access request using only a subset of the disks in the RAID, thereby permitting power savings to be made by powering down the remaining disks in the RAID, without degrading RAID performance.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

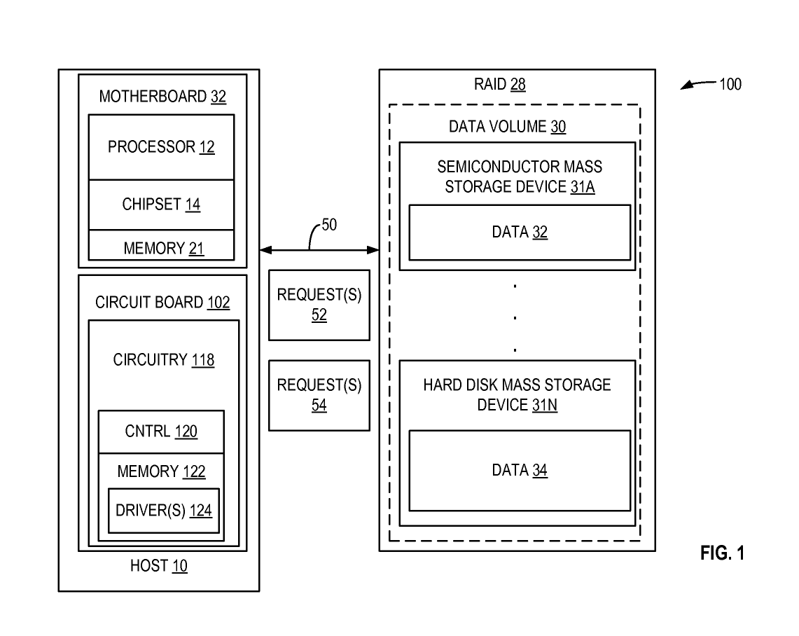

FIG. 1 illustrates a system embodiment 100. System 100 may include host 10 that may be communicatively coupled via one or more communication links 50 to RAID 28.

In this embodiment, as shown in FIG. 1, host 10 may comprise circuit board 102 and motherboard 32. Motherboard 32 may comprise one or more host processors 12. Each of the host processors 12 may be coupled (e.g., via a respective not shown segment of a proprietary bus) to a chipset 14. Each of the one or more host processors 12 may comprise, for example, a respective Intel® Core™ 2 VPro™ microprocessor that is commercially available from the Assignee of the subject application. As used herein, a “processor” means circuitry capable of performing, at least in part, one or more arithmetic and/or logical operations. Of course, alternatively, each of the host processors 12 may comprise, for example, a respective microprocessor that is manufactured and/or commercially available from a source other than the Assignee of the subject application, without departing from this embodiment.

Chipset 14 may comprise a not shown memory controller hub that may couple one or more host processors 12, a system memory 21 and a not shown user interface system to each other and to a not shown bus system. Chipset 14 may comprise one or more integrated circuit chips selected from, for example, one or more integrated circuit chipsets available from the Assignee of the subject application (e.g., memory controller hub and I/O controller hub chipsets), although one or more other integrated circuit chips may also, or alternatively be used, without departing from this embodiment. The not shown user interface system may comprise, e.g., a keyboard, pointing device, and display system that may permit a human user to input commands to, and monitor the operation of, system 100. The not shown bus system may comprise one or more buses that may comply with the bus protocol described in Peripheral Component Interconnect (PCI) Express™ Base Specification Revision 1.0, published Jul. 22, 2002, available from the PCI Special Interest Group, Portland, Oreg., U.S.A. Alternatively, the bus may comprise other types of bus systems, without departing from this embodiment.

Controller circuit card 102 in host 10 may be communicatively coupled to RAID 28 via links 50, and may control the operation of RAID 28. In this embodiment, RAID 28 may comprise a plurality of storage devices 31A . . . 31N. Each of the storage devices 31A . . . 31N may comprise a respective mass storage device. Although this Detailed Description will proceed with reference being made to RAID 28 implementing a RAID level of 1 (i.e., mirroring), the RAID level that may be implemented by the mass storage devices 31A . . . 31N in RAID may be 0, 1, or greater than 1. Depending upon, for example, the RAID level implemented in RAID 28, the number of storage devices comprised in storage devices 31A . . . 31N may vary so as to permit the number of such storage devices to be at least sufficient to implement the RAID level so implemented.

As used herein, the term “storage device” may be used to mean one or more apparatus into, and/or from which, data may be stored and/or retrieved, respectively. Also, as used herein, the term “mass storage” means storage device capable of non-volatile storage of data. For example, in this embodiment, mass storage may include, without limitation, one or more non-volatile magnetic, optical, and/or semiconductor storage devices. As used herein, “circuitry” may comprise, for example, singly or in any combination, analog circuitry, digital circuitry, hardwired circuitry, programmable circuitry, state machine circuitry, and/or memory that may comprise program instructions that may be executed by programmable circuitry.

As shown in FIG. 1, mass storage device 31A may be a semiconductor mass storage device. (e.g., solid state disk device), and mass storage device 31N may be a magnetic, electro-mechanical mass storage device (e.g., hard disk device). However, many variations are possible without departing from this embodiment. For example, each of the mass storage devices 31A . . . 31N may be a respective electro-mechanical mass storage device without departing from this embodiment.

Controller circuit card 102 may comprise operative circuitry 118. Operative circuitry 118 may comprise storage I/O controller 120 and memory 122.

Processors 12, system memory 21, and chipset 14 may be comprised in a single circuit board, such as, for example, system motherboard 32. Motherboard 32 also may comprise the not shown bus system and a not shown bus card slot. Card 102 may include a not shown bus connector that may be capable of being electrically and mechanically coupled to the bus card slot that may be comprised in the motherboard 32. When the bus connector of card 102 is so coupled to the bus card slot comprised in motherboard 32, operative circuitry 118 may become communicatively coupled to mother board 32.

Alternatively, without departing from this embodiment, some or all of the operative circuitry 118 of controller card 102 may not be comprised in card 102, but instead, may be comprised in other structures, systems, and/or devices. These other structures, systems, and/or devices may be, for example, comprised in motherboard 32 (e.g., as part of host processor 12 and/or chipset 14).

One or more machine-readable program instructions may be stored in computer-readable memory 122 and/or 21. In operation of system 100, these instructions may be accessed and executed by controller 120 and/or one or more host processors 12. When executed by controller 120 and/or one or more host processors 12, these one or more instructions may result in controller 120, operative circuitry 118, host processor 12, and/or card 102 performing the operations described herein as being performed by controller 120, operative circuitry 118, host processor 12, and/or card 102.

Each storage device 31A . . . 31N may be comprised in one or more respective enclosures that may be separate from one or more enclosures in which the respective components of RAID 28 may be enclosed. Alternatively, one or more of the storage devices 31A . . . 31N may be comprised in one or more of the enclosures that may comprise the respective components of RAID 28.

Communication links 50 may be compatible with one or more communication protocols, and circuitry 118 may exchange data and/or commands with RAID 28 via links 50, in accordance with these one or more communication protocols. For example, in this embodiment, one or more links 50 may be compatible with, and the respective operative circuitry 118 may exchange data and/or commands with RAID 28 in accordance with, e.g., an Ethernet protocol, Transmission Control Protocol/Internet Protocol (TCP/IP) protocol, Fibre Channel (FC) protocol, Small Computer Systems Interface (SCSI) protocol, Serial Advanced Technology Attachment (S-ATA) protocol and/or Serial Attached Small Computer Systems Interface (SAS) protocol. The Ethernet protocol utilized in system 100 may comply or be compatible with the protocol described in Institute of Electrical and Electronics Engineers, Inc. (IEEE) Std. 802.3, 2000 Edition, published on Oct. 20, 2000. Alternatively or additionally, the TCP/IP protocol utilized in system 100 may comply or be compatible with the protocols described in Internet Engineering Task Force (IETF) Request For Comments (RFC) 791 and 793, published September 1981. The FC protocol that may be utilized in system 100 may be compatible with the interface/protocol described in ANSI Standard Fibre Channel (FC) Physical and Signaling Interface-3 X3.303:1998 Specification. The SCSI protocol that may be utilized in system 100 may be compatible with the protocol described in American National Standards Institute (ANSI) Small Computer Systems Interface-2 (SCSI-2) ANSI X3.131-1994 Specification. The S-ATA protocol that may be utilized in system 100 may be compatible with the protocol described in “Serial ATA: High Speed Serialized AT Attachment,” Revision 1.0, published on Aug. 29, 2001 by the Serial ATA Working Group. The SAS protocol that may be utilized in system 100 may be compatible with the protocol described in “Information Technology—Serial Attached SCSI (SAS),” Working Draft American National Standard of International Committee For Information Technology Standards (INCITS) T10 Technical Committee, Project T10/1562-D, Revision 2b, published 19 Oct. 2002, by American National Standards Institute. Of course, many different communication protocols may be used for such data and/or command exchange without departing from this embodiment.

Computer-readable memory 21 and 122 may each comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable memory.

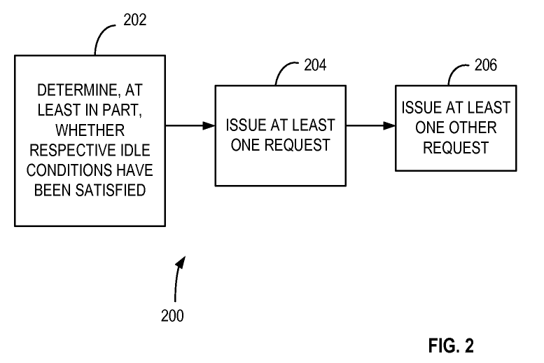

FIG. 2 is a flowchart illustrating operations 200 that may be performed in system 100 according to an embodiment. In this embodiment, the execution by controller 120 and/or processor 12 of the one or more instructions that may be stored in memory 21 and/or memory 122 may result in one or more program processes and/or drivers 124 being executed by controller 120 and/or processor 12 and becoming resident in memory 21 and/or memory 122 (although for purposes of clarity of visual description, one or more processes and/or drivers 124 are shown in FIG. 1 as being resident in memory 122). The execution of these one or more program processes and/or drivers 124 by controller 120 and/or processor 12 may result in circuitry 118, controller 120 and/or processor 12 carrying out operations 200 shown in FIG. 2. For example, as part of these operations 200, controller 120, circuitry 118, and/or processor 12 may determine, at least in part, whether respective idle conditions have been satisfied for respective storage devices 31A . . . 31N, as illustrated by operation 202 in FIG. 2.

For example, in this embodiment, as a result, at least in part, of the execution by processor 12 and/or controller 120 of these one or more drivers 124, as part of operation 202, processor 12, circuitry 118, and/or controller 120 may maintain respective idle timers for each the respective storage devices 31A . . . 31N, and may monitor system 100 for issuance of any requests to RAID 28 that involve accessing any of the storage devices 31A . . . 31N. In this embodiment, an “access” to a storage device includes an operation to be performed by and/or implemented using the storage device that involves the storage and/or writing of data to, the reading and/or retrieving of data from, and/or the modification of any data stored in the storage device. After, for example, a reset of system 100, processor 12, controller 120, and/or circuitry 118 may initialize each of these idle timers to respective predetermined initial values (which may be the same or different from each other for all or some of the idle timers), and each of the storage devices 31A . . . 31N may be placed in a fully powered-up, operational state. If, thereafter, but prior to the expiration of one or more respective idle timers associated with one or more respective storage devices (e.g., storage device 31A) one or more respective requests to access the one or more respective storage devices 31A are issued in system 100, the processor 12, controller 120, and/or circuitry 118 may reset the one or more respective idle timers to the one or more respective predetermined initial values of the one or more respective idle timers. Conversely, if one or more respective requests are not issued to one or more respective storage devices (e.g., storage device 31N) prior to the expiration of the one or more respective idle timers associated with these one or more respective storage devices, processor 12, controller 120, and/or circuitry 118 may determine, at least in part, as part of operation 202, that at least one respective storage device (e.g., storage device 31N) satisfies at least one respective idle condition.

If, as a result of operation 202, processor 12, controller 120, and/or circuitry 118 determines, at least in part, that at least one respective storage device (e.g., storage device 31N) satisfies at least one respective idle condition, circuitry 118 may generate and issue at least one request 52 to RAID 28 via one or more links 50, as illustrated by operation 204 in FIG. 2. Request 52 may request that the at least one storage device 31N that has been determined to satisfy the respective idle condition enter, independently from at least one other respective storage device (e.g., storage device 31A) in RAID 28, a respective relatively lower power consumption state compared to its current relatively higher power consumption state.

For example, in this embodiment, if as a result of operation 202, processor 12, controller 120, and/or circuitry 118 determines, at least in part, that at least one respective storage device (e.g., storage device 31N) satisfies at least one respective idle condition, but at least one storage device (e.g., storage device 31A) in RAID 28 does not satisfy at least one respective idle condition, at least one request 52, issued as a result of operation 204, may request that only the at least one respective storage device (e.g., storage device 31N) that has been determined to satisfy the at least one respective idle condition enter at least one respective relatively lower power consumption state compared to at least one current relatively higher power consumption state.

In response, at least in part, to receipt by RAID 28 of at least one request 52, the at least one respective storage device 31N determined, at least in part, as a result of operation 202, to satisfy the at least one respective idle condition, may enter at least one respective relatively lower power consumption state, which may involve being totally powered down and/or spindle powered-down. Conversely, however, after receipt by RAID 28 of at least one request 52, the at least one storage device 31A that does not satisfy at least one respective idle condition may remain in respective fully powered-up, operational states.

After the initial execution of operation 202, processor 12, controller 120, and/or circuitry 118 may continue to periodically monitor for issuance of one or more requests to access one or more storage devices 31A . . . 31N. If, for example, after execution of operation 204, processor 12, controller 120, and/or circuitry 118 determines that one or more respective requests to access the one or more respective storage devices 31N have been issued in system 100, circuitry 118 may generate and issue one or more requests 54 to RAID 28 via one or more links 50, as illustrated by operation 206 in FIG. 2. One or more requests 54 may request that the at least one storage device 31N that is currently in at least one respective relatively lower power state enter at least one respective relatively higher power state (e.g., fully powered-up and operational), for example, in order to be fully able to satisfy the one or more access requests that have been issued. In response, at least in part, to receipt by RAID 28 of at least one request 54, this at least one storage device 31N may become fully powered-up and operational. Thereafter, processor 12, controller 120, and/or circuitry 118 may continue to periodically execute operation 202 (and as appropriate, operations 204 and 206) in accordance with the above teachings concerning this embodiment.

Thus, in one system, an apparatus is provided that includes circuitry to determine, at least in part, whether respective idle conditions have been satisfied for respective storage devices. If the circuitry determines, at least in part, that at least one respective storage device comprised in the respective storage devices satisfies at least one respective idle condition, the circuitry is also to issue at least one request that the at least one respective storage device enter, independently from at least one other respective storage device comprised in the respective storage devices, a respective relatively lower power consumption state compared to a respective relatively higher power consumption state.

Advantageous usage models are facilitated as a result of this embodiment. For example, as stated above, in this embodiment, RAID 28 may implement mirroring (e.g., data 32 stored in storage device 31A is mirrored by data 34 stored in storage device 31N), storage device 31A may be a semiconductor mass storage device (e.g., a solid state disk device), and storage device 31N may be an electro-mechanical mass storage device (e.g., hard disk device). Semiconductor mass storage device 31A may consume less power, when it is in a fully powered-up and operational state, then hard disk mass storage device 31N may consume when hard disk mass storage device 31N is in a fully powered-up and operational state. Due to fact that data 32 may mirror data 34, this may permit a request to read the data comprised in data 32 and 34 to be satisfied by reading data 32 from semiconductor mass storage device 31A instead of by accessing data 34 from hard disk storage device 31N. Advantageously, since in this embodiment, the respective power consumption state of each respective storage device 31A . . . 31N in RAID 28 may be individually controlled, independently of any other storage device in RAID 28, based upon whether each respective storage device satisfies a respective idle condition (in stark contrast to the prior art wherein, e.g., RAID power management policy is implemented for the RAID viewed as a single unit), this may permit significantly less power to be consumed in this embodiment compared to the prior art, since the read request may be satisfied by reading only storage device 31A, and storage device 31N may be powered-down when it satisfies its respective idle condition.

Alternatively or additionally, without departing from this embodiment, each of the storage devices 31A . . . 31N may comprise a respective hard disk mass storage device, and RAID 28 may comprise a data volume 30 that may span (e.g., comprise a linear concatenation of), at least in part, storage devices 31A and 31N. In this arrangement, data 32 may comprise data that is expected to be more frequently accessed (e.g., user programs, operating system files, etc.) while data 34 may comprise data is expected to be relatively less frequently accessed (e.g., media files, bulk storage, pictures, etc.). As a result, most of the access requests to volume 30 may be satisfied by accessing data 32 in storage device 31A, and therefore, it is likely that storage device 31N will satisfy its respective idle condition more frequently than storage device 31A will satisfy its respective idle condition. Advantageously, since in this embodiment, the respective power consumption state of each respective storage device 31A . . . 31N in RAID 28 may be individually controlled, independently of any other storage device in RAID 28, based upon whether each respective storage device satisfies a respective idle condition (in stark contrast to the prior art wherein, e.g., RAID power management policy is implemented for the RAID viewed as a single unit), this may permit significantly less power to be consumed in this embodiment compared to the prior art, since most of the access requests to volume 30 are likely to be satisfied by accessing only storage device 31A, and therefore, storage device 31N may satisfy its respective idle condition and be powered-down relatively more often than in the prior art.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Indeed, without departing from this embodiment, system 100 may include more or fewer than the elements shown in the Figures and described previously herein as being comprised system 100. Also, without departing from this embodiment, operations 200 may be implemented in whole or in part by one or more drivers 124. For example, the respective idle timers, the monitoring of access requests, and the issuing of requests 52 and 54 to RAID to power down or power up individual mass storage devices, respectively, as described above in connection with operations 200, may be implemented and/or carried out by one or more drivers 124. Accordingly, the claims are intended to cover all such equivalents.

What is claimed is:

1. An apparatus comprising:
circuitry to determine, at least in part, whether respective idle conditions have been satisfied for respective storage devices, and if the circuitry determines, at least in part, that at least one respective storage device comprised in the respective storage devices satisfies at least one respective idle condition, the circuitry is also to issue at least one request that the at least one respective storage device enter, independently from at least one other respective storage device comprised in the respective storage devices, a respective relatively lower power consumption state compared to a respective relatively higher power consumption state.

2. The apparatus of claim 1, further comprising a redundant array of independent disks (RAID) that comprises the at least one respective storage device and the at least one other respective storage device.

3. The apparatus of claim 2, wherein:
the at least one respective storage device mirrors the at least one other respective storage device;
the at least one respective storage device comprises a hard disk mass storage device; and
the at least one other respective storage device comprises a semiconductor mass storage device.

4. The apparatus of claim 1, wherein:
the apparatus further comprises the at least one respective storage device and the at least one other respective storage device; and
if the circuitry determines, at least in part, that the at least one other respective storage device has not entered at least one other respective idle condition, then after the at least one request is issued the at least one other respective storage device remains in a respective unchanged power consumption state compared to prior to issuance of the request.

5. The apparatus of claim 1, further comprising a data volume that spans the at least one respective storage device and the at least one other respective storage device.

6. The apparatus of claim 1, wherein in response at least in part, to a determination that access to the at least one respective storage device has been requested, the circuitry is also to issue at least one other request that the at least one respective storage device enter the respective relatively higher power state.

7. Machine-readable memory storing one or more instructions that when executed by a machine result in execution of operations comprising:
determining, at least in part, whether respective idle conditions have been satisfied for respective storage devices; and
if the determining, at least in part, determines that at least one respective storage device comprised in the respective storage devices satisfies at least one respective idle condition, issuing at least one request that the at least one respective storage device enter, independently from at least one other respective storage device comprised in the respective storage devices, a respective relatively lower power consumption state compared to a respective relatively higher power consumption state.

8. The memory of claim 7, wherein:
a redundant array of independent disks (RAID) comprises the at least one respective storage device and the at least one other respective storage device.

9. The memory of claim 8, wherein:
the at least one respective storage device mirrors the at least one other respective storage device;
the at least one respective storage device comprises a hard disk mass storage device; and
the at least one other respective storage device comprises a semiconductor mass storage device.

10. The memory of claim 7, wherein:
if the determination, at least in part, determines that the at least one other respective storage device has not entered at least one other respective idle condition, then after the at least one request is issued the at least one other respective storage device remains in a respective unchanged power consumption state compared to prior to issuance of the request.

11. The memory of claim 7, wherein a data volume spans the at least one respective storage device and the at least one other respective storage device.

12. The memory of claim 7, wherein the operations further comprise, in response at least in part, to a determination that access to the at least one respective storage device has been requested, issuing at least one other request that the at least one respective storage device enter the respective relatively higher power state.

13. The memory of claim 12, wherein:
the determining is carried out, at least in part, by one or more drivers based, at least in part, upon one or more respective timers associated with the at least one respective storage device, the one or more respective timers being implemented, at least in part, by the one or more drivers;
the one or more drivers also perform, at least in part, the determination; and
the one or drivers initiate issuance, at least in part, of the at least one request and the least one other request.

14. The apparatus of claim 1, wherein:
determination of whether the respective idle conditions have been satisfied is carried out, at least in part, by one or more drivers based, at least in part, upon one or more respective timers associated with the at least one respective storage device, the one or more respective timers being implemented, at least in part, by the one or more drivers;
the one or more drivers also perform, at least in part, another determination that access to the at least one respective storage device has been requested; and
the one or drivers initiate issuance, at least in part, of the at least one request and the least one other request.
